(19) United States
(12) Patent Application Publication
(10) Pub. No.: US 2026/0055346 A1
(43) Pub. Date: Feb. 26, 2026

(54) A CLEANING COMPOSITION

(71) Applicant: CONOPCO, INC., D/B/A UNILEVER, Englewood Cliffs, NJ (US)

(72) Inventors: Girish MURALIDHARAN, Banashankari (IN); Balu KUNJUPILLAI, Bangalore (IN); Vishal Mohan UDMALE, Virar (IN)

(21) Appl. No.: 19/105,948

(22) PCT Filed: Aug. 24, 2023
(86) PCT No.: PCT/EP2023/073262

§ 371 Date: Feb. 24, 2025

(30) Foreign Application Priority Data
Aug. 25, 2022 (EP) 22192162.0

(51) Int. Cl. C11D 3/22; C11D 1/22; C11D 1/66; C11D 1/90; C11D 1/94; C11D 3/00; C11D 3/20; C11D 3/36; C11D 3/37; C11D 3/42; C11D 17/04; C11D 17/06

(52) U.S. Cl. CPC C11D 3/225; C11D 1/22; C11D 1/662; C11D 1/90; C11D 1/94; C11D 3/0036; C11D 3/2065; C11D 3/361; C11D 3/3715; C11D 3/3723; C11D 3/3765; C11D 3/42; C11D 17/043; C11D 17/06; C11D 2111/12

(57) ABSTRACT

The present invention is in the field of cleaning compositions. More particularly, the present invention relates to a laundry cleaning composition for providing improved cleaning benefit. enhanced stain removal benefit. There is a need for a ‘eco-friendly’ cleaning composition having cleaning boosters that provides enhanced cleaning efficacy It provides a laundry cleaning composition providing enhanced. It is found that a cleaning composition comprising specific amount of a water-soluble cellulose containing compound along with select cleaning boosters provides a stable liquid cleaning composition that has a good ‘eco-friendly’ profile and provides improved stain removal benefit. The present invention further describes a unit does product and a process for cleaning a substrate involving the cleaning composition.

### FIELD OF THE INVENTION

The present invention is in the field of cleaning compositions. More particularly, the present invention relates to a laundry cleaning composition comprising a water-soluble cellulose containing compound and a cleaning booster providing improved stain removal benefit.

### BACKGROUND OF THE INVENTION

Consumers prefer to use various cleaning products for their house-hold chores. Laundry detergent, dishwashing detergent, hard surface cleaners are few examples of such cleaning products. Often these products are available in various formats, such as, powder, bar, liquid, pods, sheet etc.

A detergent product typically contains one or more detersive active for cleaning benefit. It may further contain certain additional ingredients for enhancing or boosting the cleaning efficacy and sensory. Such ingredients are often grouped as cleaning boosters. Examples of such ingredients include sequestrant, soil release polymer, anti-redeposition polymer, anti-foaming agent, builders, shading dye, fluorescer, and perfume. A conventional detergent product further contains substantial amount of a carrier, mostly, it is water for liquid format and inert fillers for solid format.

It is observed that consumers are now-a-days concerned about the environment. They prefer ‘eco-friendly’ or ‘environmental-friendly’ products, i.e., the products, which contain natural or biodegradable ingredients or ingredients are sourced through renewable routes or have less or no impact on the environment when the product is made or used.

Cleaning products formulated with renewable materials are one step in this direction. It is desired that such products provide a cleaning efficacy at least at-par with the conventional detergent products or even better. Particularly, in laundry context, it is desired that the product removes stains from substrates efficiently.

In this regards, WO 2017/164569 A1 (Yoo Shi Chang, 2017) discloses a paper-type detergent comprising 10 to 20 parts by weight of starch, 25 to 35 parts by weight of a non-ionic surfactant, 8 to 12 parts by weight of an anionic surfactant, 10 to 20 parts by weight of an emulsifier, 6 to 10 parts by weight of a dispersant, 10 to 15 parts by weight of a film forming agent, 2 to 5 parts by weight of a composite enzyme, 2 to 4 parts by weight of a nano-silver antibacterial agent and 3 to 5 parts by weight of deionized water.

EP 1 163 895 A1 (Kao Corp., 2001) discloses detergent compositions comprising components (A) and (B): (A) 3 to 60% by weight of at least one surfactant selected from anionic surfactants, amphoteric surfactants and hydrophilic non-ionic surfactants; and (B) 0.1 to 50% by weight of fibre having an average fibre length of 0.02 to 1 mm.

CN 107 201 279 (Kesh Chemical Ind Shenzhen Co. Ltd., 2017) discloses a washing tablet and preparation method thereof. The tablet is prepared from a film forming agent, a non-ionic surfactant, an anionic surfactant, a zwitterionic surfactant, a moisturizer, a chelating agent, a preservative, edible pigment, natural essence and the like, and is prepared by the following steps of weighing, pulping, tabletting and the like.

Although there are cleaning compositions are disclosed, still there is a need for a ‘eco-friendly’ cleaning composition having cleaning boosters that provides enhanced cleaning efficacy.

The present inventors surprisingly have found that specific amount of a water-soluble cellulose containing compound along with select cleaning boosters, provides a stable liquid cleaning composition that has a good ‘eco-friendly’ profile and provides improved stain removal benefit.

### SUMMARY OF THE INVENTION

In a first aspect, the present invention provides a laundry cleaning composition comprising:
a) 10 to 80% by weight of a surfactant;
b) at least 5% by weight of a cellulose containing compound having a solubility at least 0.5% by weight in distilled water at 25° C.; and,
c) a cleaning booster selected from sequestrant, soil release polymer, and anti-redeposition polymer and combinations thereof.

In another aspect, the present invention provides a unit dose product comprising a cleaning composition according to the first aspect in a water-soluble pouch.

In another aspect, the present invention provides a process for cleaning a substrate comprising steps of:
a) providing water in a container;
b) dissolving a cleaning composition according to the first aspect in the water thereby providing a wash liquor; and
c) applying the wash liquor for cleaning the substrate.

These and other aspects, features and advantages will become apparent to those of ordinary skill in the art from reading of the following detailed description. For the avoidance of doubt, any feature of one aspect of the present invention may be utilized in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### DETAILED DESCRIPTION OF THE INVENTION

According to the present invention, there is provided a laundry cleaning composition comprising 10 to 80% by weight of a surfactant, at least 5% by weight of a cellulose containing compound having a solubility at least 0.5% by weight in distilled water at 25° C., and a cleaning booster selected from sequestrant, soil release polymer, anti-redeposition polymer and combinations thereof.

### Surfactant

The cleaning composition comprises 10 to 80% by weight of the surfactant. Preferably the cleaning composition comprises 15 to 75% by weight, more preferably 20 to 70%, even more preferably 20 to 65% by weight, and most preferably 20 to 60% by weight of the surfactant.

Preferably the surfactant is selected from anionic surfactant, non-ionic surfactant, amphoteric surfactant, and combinations thereof.

Preferably the cleaning composition comprises anionic surfactant. Preferably the anionic surfactant is selected from alkyl sulphate, alkyl ether sulphate, linear alkyl benzene sulphonate and combinations thereof.

Anionic surfactant suitable for the present invention includes salts of organic sulphates and sulphonates having alkyl radicals containing from about 8 to about 22 carbon atoms, the term “alkyl” being used to include the alkyl portion of higher acyl radicals. Examples of such materials include alkyl sulphates, alkyl ether sulphates, alkaryl sulfonates, alpha-olefin sulfonates and mixtures thereof. The alkyl radicals preferably contain from 10 to 18 carbon atoms and may be unsaturated. The alkyl ether sulphates may contain from one to ten ethylene oxide or propylene oxide units per molecule, and preferably contain one to three ethylene oxide units per molecule.

The suitable anionic surfactant may also include alkylbenzene sulfonates. Preferably in an embodiment suitable for dishwash comprises linear alkylbenzene sulfonates (LAS) with an alkyl chain length of from 10 to 18 carbon atoms. Commercial LAS is a mixture of closely related isomers and homologues alkyl chain homologues, each containing an aromatic ring sulfonated at the “para” position and attached to a linear alkyl chain at any position except the terminal carbons. The linear alkyl chain typically has a chain length of from 11 to 15 carbon atoms, with the predominant materials having a chain length of about C12. Each alkyl chain homologue consists of a mixture of all the possible sulpho-phenyl isomers except for the 1-phenyl isomer. LAS is normally formulated into compositions in acid (i.e., HLAS) form and then at least partially neutralized in-situ. The counterion for anionic surfactants is generally an alkali metal such as sodium or potassium; or an ammoniacal counterion. Mixtures of such counterions may also be employed. Sodium and potassium are preferred.

Preferably the suitable anionic surfactant includes alkyl sulphate surfactant (PAS), such as non-ethoxylated primary and secondary alkyl sulphates with an alkyl chain length of from 10 to 18.

The cleaning composition may contain alkyl ether sulphates having a straight or branched chain alkyl group having 10 to 18, more preferably 12 to 14 carbon atoms and containing an average of 1 to 3 ethylene oxide (EO) units per molecule. A preferred example is sodium lauryl ether sulphate (SLES) in which the predominantly C12 lauryl alkyl group has been ethoxylated with an average of 3EO units per molecule. The alkyl ether sulphates may be used alone or in combination with any other anionic surfactant.

Most preferably the anionic surfactant is selected from primary alkyl sulphate, alkyl benzene sulphonates, alkyl ether sulphates and combinations thereof.

Preferably the amount of the anionic surfactant is in the range up to 100% by weight of the total amount of the surfactant. More preferably, the amount of anionic surfactant is in the range 10 to 100%, even more preferably 20 to 100%, even more preferably 30 to 100% by weight of the total amount of the surfactant. Most preferably the anionic surfactant is in the range of 50 to 100% by weight of the total amount of the surfactant.

Preferably the cleaning composition comprises 8 to 80% by weight, more preferably 15 to 75% by weight, even more preferably 20 to 70% by weight and most preferably 25 to 65% by weight of the anionic surfactant.

The cleaning composition according to the present invention may further comprises a non-ionic and an amphoteric surfactant in addition to the anionic surfactant.

Suitable non-ionic surfactants include water soluble aliphatic ethoxylated non-ionic surfactants including the primary aliphatic alcohol ethoxylates and secondary aliphatic alcohol ethoxylates. This includes the condensation products of a higher alcohol (e.g., an alkanol containing about 8 to 16 carbon atoms in a straight or branched chain configuration) condensed with about 4 to 20 moles of ethylene oxide, for example, lauryl or myristyl alcohol condensed with about 10 moles of ethylene oxide (EO), tridecanol condensed with about 6 to 15 moles of EO, myristyl alcohol condensed with about 10 moles of EO per mole of myristyl alcohol, the condensation product of EO with a cut of coconut fatty alcohol containing a mixture of fatty alcohols with alkyl chains varying from 10 to about 14 carbon atoms in length and wherein the condensate contains either about 6 moles of EO per mole of total alcohol or about 9 moles of EO per mole of alcohol and tallow alcohol ethoxylates containing 6 EO to 11 EO per mole of alcohol.

Examples of the foregoing non-ionic surfactants include, but are not limited to, the Neodol (trade mark, ex Shell), which are higher aliphatic, primary alcohol containing about 9 to 15 carbon atoms, such as C9 to C11 alkanol condensed with 4 to 10 moles of ethylene oxide (Neodol 91-8 or Neodol 91-5), C12 to C13 alkanol condensed with 6.5 moles ethylene oxide (Neodol 23-6.5), C12 to C15 alkanol condensed with 12 moles ethylene oxide (Neodol 25-12), C14 to C15 alkanol condensed with 13 moles ethylene oxide (Neodol 45-13), and the like. Such ethoxamers have an HLB (hydrophobic lipophilic balance) value of about 8 to 15 and give good O/W emulsification, whereas ethoxamers with HLB values below 7 contain less than 4 ethylene oxide groups and tend to be poor emulsifiers and poor detergents.

Another group of suitable non-ionic surfactants are alkyl polyglycoside (APG) which are sugar derivatives of fatty alcohol. Example of such surfactants are decyl glucoside, lauryl glucoside, myristyl glucoside.

Preferably the cleaning composition comprises 0 to 50% by weight, more preferably 5 to 45% by weight, even more preferably 10 to 40% by weight and most preferably 15 to 35% by weight of the non-ionic surfactant.

The cleaning composition may comprise an amphoteric surfactant in addition to anionic and/or non-ionic surfactant. Suitable amphoteric surfactants include derivatives of aliphatic quaternary ammonium, sulphonium and phosphonium compounds having an aliphatic radical of from 8 to 18 carbon atoms and an aliphatic radical substituted by an anionic water-solubilising group, for instance 3-(N—N-dimethyl-N-hexadecylammonium) propane-1-sulphonate betaine, 3-(dodecylmethyl sulphonium) propane-1-sulphonate betaine and 3-(cetylmethylphosphonium) ethane sulphonate betaine.

Examples of amphoteric surfactants suitable for the present invention include cocoamidopropyl betaine (CAPB), cocoamidopropyl amine oxide (CAPAO), cocodiethanol amide (CDEA) and cocomonoethanol amide (CMEA).

Preferably the cleaning composition comprises 0 to 30% by weight, more preferably 1 to 25% by weight, even more preferably 2 to 20% by weight and most preferably 3 to 20% by weight of the amphoteric surfactant.

Preferably the surfactant comprises a combination of anionic surfactant, non-ionic surfactant, and amphoteric surfactant. The ratio of the anionic surfactant to non-ionic surfactant to amphoteric surfactant preferably at least 3:1:1 by weight. More preferably the ratio of the anionic surfactant to non-ionic surfactant to amphoteric surfactant preferably is at least 5:1:1 by weight and most preferably at least 7:1:1. Preferably the ratio of the anionic surfactant to non-ionic surfactant to amphoteric surfactant is in the range 3:1:1 to 10:1:1 by weight.

### Cellulose Containing Compound

The cleaning composition comprises at least 5% by weight cellulose containing compound. Cellulose containing compounds are mostly sourced through renewable routes, thus favourable for making ‘eco-friendly products. It is observed that the cellulose containing compound in specific amount helps in removing stains from a substrate, particularly from fabrics.

The cellulose containing compound is soluble in water, having a solubility at least 0.5% by weight in distilled water at 25° C. Cellulose containing compounds are within the meaning of cellulose derivative in the understanding of a skilled person in the art. Preferably the cellulose containing compound is readily soluble in water at 25° C. The term “readily soluble” herein implies that the polymer dissolves in water in room temperature thereby providing a visually clear or transparent solution, without leaving any lump in the solution. Visually clear or transparent herein refers to a solution having a turbidity value less than 50 NTU (Nephelometric turbidity unit).

Preferably the composition comprises at least 10% by weight of the cellulose containing compound. The amount of the cellulose containing compound may be in the range 10 to 50% by weight, more preferably 10 to 45% by weight, even more preferably 10 to 40% by weight and most preferably 10 to 30% by weight of the cleaning composition.

Preferably the cellulose containing compound is cellulose ether derivative. Typically, cellulose ether derivatives are obtained by substituting one or more hydrogen atoms of hydroxyl groups in the anhydro-glucose units of cellulose with alkyl or substituted alkyl groups. Degree of substitution (DS) is one of the factors, that define the properties of cellulose ether derivatives, particularly, solubility in water. It is defined as the number of substituted hydroxyl groups for every glucose molecule ranging between zero and three. For example, cellulose ether derivatives with degree of substitution values between 1.2 to 2.4 are soluble in cold water. Examples of cellulose ether derivatives suitable for the present invention includes methyl cellulose, ethyl cellulose, ethyl methyl cellulose, hydroxyethyl cellulose, hydroxypropyl cellulose, hydroxy ethyl methyl cellulose, hydroxypropyl methyl cellulose ethyl hydroxy ethyl cellulose, carboxymethyl cellulose and sodium carboxymethyl cellulose.

Preferably the cellulose ether derivative is selected from cellulose alkyl ether derivative or cellulose hydroxyalkyl ether derivative. Non-ionic cellulose ether derivatives, i.e., derivatives containing non-ionic functional group, such as, hydroxy, methoxy, ethoxy, hydroxyethyl, hydroxy propyl, di-hydroxy propyl and dihydroxy butyl, are also suitable for the present invention.

Preferably the cellulose derivative is selected form hydroxypropyl methyl cellulose, methyl cellulose, hydroxypropyl cellulose, and combinations thereof. Most preferred cellulose derivative is hydroxypropyl methyl cellulose.

In this regard, typically pure celluloses are hardly soluble in distilled water, however they form gel by absorbing water, hence they are not suitable for the present invention.

### Cleaning Boosters

The composition comprises a cleaning booster. The term ‘cleaning booster’ in detergent context refers to ingredients that helps in enhancing the cleaning performance and sensory of the composition. These ingredients typically present in addition to detersive actives or surfactants. It is observed that the cellulose containing compounds in combination with the cleaning boosters synergistically improves the cleaning efficacy of the composition.

The cleaning booster according to the present invention is selected from sequestrant, soil release polymer, anti-redeposition polymer and combinations thereof. The composition comprises one or more of the cleaning boosters listed here.

The composition preferably comprises 0.1 to 20% by weight of the cleaning boosters. More preferably the composition comprises 0.2 to 15% by weight, even more preferably 0.5 to 12% by weight and most preferably 0.8 to 10% by weight of the cleaning boosters.

### Sequestrant

The composition may comprise a sequestrant as the cleaning booster. Preferably the sequestrant is selected from organic detergent builders or sequestrant materials. Examples of such sequestrants include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Monsanto and alkanehydroxy phosphonates.

Other suitable organic builders/sequestrants include the higher molecular weight polymers and copolymers known to have builder properties. For example, such materials include appropriate polyacrylic acid, polymaleic acid, and polyacrylic/polymaleic acid copolymers and their salts, for example those sold by BASF under the name SOKALAN™. A preferred sequestrant is Dequest® 2066 (Diethylenetriamine penta (methylene phosphonic acid) or Heptasodium DTPMP). Other suitable sequestrant is HEDP (1-Hydroxyethylidene-1,1,-diphosphonic acid), for example sold as Dequest 2010.

Preferably the sequestrant is selected from amino-phosphonic acid, phosphonic acid, amino carboxylic acid, and salts thereof. Preferably the sequestrant is selected from Diethylenetriamine penta (methylene phosphonic acid-heptasodium salt (DTPMPA), 1-Hydroxyethylidene 1,1-diphosphonic acid (HEDP), Trisodium salt of Methylglycinediacetic acid (MGDA), N,N-Dicarboxymethyl glutamic acid tetrasodium salt (GLDA) and combinations thereof. Most preferred sequestrant is diethylenetriamine penta (methylene phosphonic acid-heptasodium salt (DTPMPA) and/or 1-hydroxyethylidene 1,1-diphosphonic acid (HEDP).

The composition preferably comprises 0.1 to 20% by weight, more preferably 0.2 to 15% by weight, even more preferably 0.5 to 12% by weight and most preferably 0.8 to 10% by weight of the sequestrant.

### Anti-Redeposition Polymer

The composition may comprise an anti-redeposition polymer as the cleaning booster. Anti-redeposition polymers typically stabilise the soil in the wash solution thus preventing redeposition of the soil. Suitable soil release polymers for use in the invention include alkoxylated polyethyleneimines. Polyethyleneimines are materials composed of ethylene imine units —CH2CH2NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (Mw). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone. Mixtures of any of the above-described materials may also be used. Most preferred anti-redeposition polymer is polyethyleneimines.

The composition preferably comprises from 0.025 to 15% by weight, more preferably 0.05 to 12% by weight, even more preferably 0.1 to 10% by weight and most preferably 0.2 to 8% by weight of the anti-redeposition polymers.

### Soil Release Polymer (SRP)

The composition may comprise a soil release polymer as the cleaning booster. Soil release polymers often help to improve the detachment of soils from fabric by modifying the fabric surface during washing. The adsorption of soil release polymer over the fabric surface is prompted by an affinity between the chemical structure of the soil release polymer and the target fibre.

Soil release polymer for use in the invention may include a variety of charged (e.g., anionic) as well as non-charged monomer units and structures may be linear, branched or star shaped. The soil release polymer's structure may also include capping groups to control molecular weight or to alter polymer properties such as surface activity. The weight average molecular weight (Mw) of the SRP may suitably range from about 1000 to about 20,000 and preferably ranges from about 1500 to about 10,000.

Soil release polymers for use in the invention may suitably be selected from co-polyesters of dicarboxylic acids (for example adipic acid, phthalic acid or terephthalic acid), diols (for example ethylene glycol or propylene glycol) and polydiols (for example polyethylene glycol or polypropylene glycol). The co-polyester may also include monomeric units substituted with anionic groups, such as for example sulfonated isophthaloyl units. Examples of such materials include oligomeric esters produced by transesterification/oligomerization of poly(ethyleneglycol) methyl ether, dimethyl terephthalate (“DMT”), propylene glycol (“PG”) and poly(ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate.

Other types of the soil release polymer for use in the invention include polymers with poly(vinyl ester) hydrophobic segments such as graft copolymers of poly(vinyl ester), for example C1-C6 vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

Preferred soil release polymer for use in the present invention include co-polyesters formed by condensation of terephthalic acid ester and diol, preferably 1,2 propanediol, and further comprising an end cap formed from repeat units of alkylene oxide capped with an alkyl group. Examples of such materials have a structure corresponding to general formula (I):

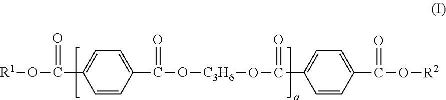

in which R¹ and R² independently of one another are X—(OC₂H₄)ₙ—(OC₃H₆)ₘ; X is C1 to C4 alkyl and preferably methyl; n is a number from 12 to 120, preferably from 40 to 50; m is a number from 1 to 10, preferably from 1 to 7; and a is a number from 4 to 9. Since m, n and a are averages, they may not necessarily whole numbers for the polymer in bulk. Mixtures of any of the above-described materials may also be used.

The amount of the soil release polymer, when included, may range from 0.1 to 15% by weight of the composition. More preferably the amount of SRP is in the range 0.2 to 12% by weight, even more preferably 0.4 to 10% and yet more preferably 0.5 to 8% by weight and most preferably 0.5 to 5% by weight of the composition.

Suitable soil release polymers are described in greater detail in U.S. Pat. Nos. 5,574,179; 4,956,447; 4,861,512; 4,702,857, WO 2007/079850 and WO2016/005271.

Preferably the composition one or more of the cleaning boosters selected from the sequestrant, anti-redeposition polymer and soil release polymer described hereinabove. Most preferred cleaning booster is a combination of the sequestrant, anti-redeposition polymer and soil release polymer.

### Further Optional Ingredients

The cleaning composition may further contain optional ingredients to enhance performance and/or consumer acceptability. Examples of such ingredients include foam control or anti foam agent, preservatives (e.g., bactericides), fluorescers, optical brighter, degreaser, shading dyes etc. Each of these ingredients will be present in an amount effective to accomplish its purpose. Generally, these optional ingredients are included individually at an amount of up to 10% by weight of the cleaning composition. Suitable antifoaming agents include silicones and fatty acids.

The cleaning composition may comprises an effective amount of one or more enzyme preferably selected from the group comprising, hemicellulases, peroxidases, proteases, cellulases, hemicellulases, xylanases, xantanase, lipases, phospholipases, esterases, cutinases, pectinases, carrageenases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, tannases, amylases, nucleases (such as deoxyribonuclease and/or ribonuclease), phosphodiesterases, or mixtures thereof. Particularly preferred are mixtures of protease, amylase, lipase, cellulase, phosphodiesterase, and/or pectate lyase.

The composition may be formulated as a laundry liquid. In such case, the composition may comprise 30 to 90% by weight, more preferably 40 to 80% and more preferably 50 to 75% by weight of water. Preferably water works as balance ins such compositions.

The composition in liquid format may have a viscosity from 200 to about 10,000 mPa·s at 25° C. at a shear rate of 21 sec⁻¹. This shear rate is the shear rate that is usually exerted on the liquid when poured from a bottle. Pourable liquid detergent compositions preferably have a viscosity of from 200 to 1,500 mPa·s, preferably from 200 to 700 mPa·s.

### Unit Dose Product

There is provided a unit dose product comprising the cleaning composition in a water-soluble pouch. The term ‘unit does’ herein refers to a dose of a product suitable for single time use. The cleaning composition may be available in liquid or powder format. In liquid format, water may be added and in powder format inert filler may be added to the composition as carrier.

Preferably the water-soluble pouch made of water-soluble film. Preferably the water-soluble film comprises a water dissoluble polymer, such as polyvinyl alcohol (PVOH), including homopolymers thereof (e.g., including substantially only vinyl alcohol and vinyl acetate monomer units) and copolymers thereof (e.g., including one or more other monomer units in addition to vinyl alcohol and vinyl acetate units). Other water soluble polymers for use in addition to the PVOH polymers and PVOH copolymers in the blend can include, but are not limited to modified polyvinyl alcohols, polyacrylates, water-soluble acrylate copolymers, polyvinyl pyrrolidone, polyethyleneimine, pullulan, water-soluble natural polymers including, but not limited to, guar gum, gum Acacia, xanthan gum, carrageenan, and starch, water-soluble polymer derivatives including, but not limited to, modified starches, ethoxylated starch, and hydroxy-propylated starch, copolymers of the forgoing and combinations of any of the foregoing. Yet other water-soluble polymers can include poly-alkylene oxides, polyacrylamides, polyacrylic acids and salts thereof, celluloses, cellulose ethers, cellulose esters, cellulose amides, polyvinyl acetates, poly-carboxylic acids, and salts thereof, polyaminoacids, polyamides, gelatines, methylcelluloses, carboxymethyl celluloses and salts thereof, dextrin, ethyl celluloses, hydroxyethyl celluloses, hydroxypropyl methylcelluloses, maltodextrins, and polymethacrylates. Such water-soluble polymers, whether PVOH or otherwise are commercially available from a variety of sources. Any of the foregoing water-soluble polymers are generally suitable for use as film-forming polymers. In general, the water-soluble film can include copolymers and/or blends of the foregoing resins.

The water-soluble film may further contain other auxiliary agents and processing agents, such as, but not limited to, plasticizers, plasticizer compatibilizers, surfactants, lubricants, release agents, fillers, extenders, cross-linking agents, antiblocking agents, antioxidants, detackifying agents, antifoams, aversive agents or bitterants (e.g., denatonium benzoate, denatonium saccharide, and denatonium chloride; sucrose octa-acetate; quinine) and other functional ingredients, in amounts suitable for their intended purposes.

### Detergent Sheet

The cleaning composition may be formulated as a detergent sheet. The composition comprises the cellulose containing compound, which may also serve as water-soluble matrix for the detergent sheet in addition to improving cleaning efficacy. Typically, detergent sheets are compact in size, thus consumes lesser packaging materials, lesser space on storage/transportation as compared to conventional product formats such as, liquid or powder. In practice, consumers are likely to dissolve a detergent sheet in water forming a wash liquor for cleaning their wash load. It may also possible that consumers prepare a liquid detergent by dissolving a detergent sheet in water and store it in a secondary container for later use. In this regard, the liquid detergent is preferably comparable to conventional liquid detergents and differs from the wash liquor in terms of amount of detersive actives and certain attributes, such as viscosity and sensory.

Conventionally, a cleaning product or detergent in sheet format comprises polyvinyl alcohol (PVA). PVA works as water-soluble matrix/substrate for sheet format. However, the present invention may not require PVA since cellulose derivative may serve the same purpose. Further, cellulose derivatives are mostly soured through renewable routes, thus it is favourable for making the product in ‘eco-friendly’ manner.

The detergent sheet may be provided as unit does. It is possible to provide the detergent sheet with perforation marking indicating a unit dose. In practice, consumers tear a unit dose by the marking and use it. It may also possible that the detergent sheet is provided as booklet of sheets, whereas each sheet corresponds to a unit dose. It is preferable, sheets have low coefficient of friction or may contain slip additives, such that they do not stick together. Thus, in such format, the detergent sheet may contain slip additive, such as erucamide, oleamide, steramide, to reduce the coefficient of friction. It may also contain other additives to improve dissolution of the sheets in water. Optionally, it may contain conventional additives used in packaging or film substrates. Examples of such ingredients include, but are not limited to, an antioxidant, a foaming agent, a dye, fillers, colourants, a cross-linking agent, an inhibitor, pigment, stabiliser and biocidal.

The cleaning composition in detergent sheet format may further comprise a swellable disintegrant. Swellable disintegrant herein refers to the components which swell in contact with water and there by accelerates dissolution of the cleaning composition. Particularly, in the present invention swellable disintegrant are referring to one which has a water absorption ratio (WAR) of greater than 1.

Water Absorption Ratio (WAR) is a measure as to how much water a material absorbs under controlled and defined conditions. The process described in ASTM D570 is used in this application.

The swellable disintegrant is selected from microcrystalline cellulose, sodium starch glycolate and mixtures thereof. Most preferred swellable disintegrant is microcrystalline cellulose. Microcrystalline cellulose absorbs water and swells and has WAR value more than 5. Most preferred swelleble disintegrant is microcrystalline cellulose.

The cleaning composition in detergent sheet format may comprise from 0.1 to 20% by weight swellable disintegrant, more preferably from 0.5 to 15% by weight and most preferably from 1 to 10% by weight swellable disintegrant.

The cleaning composition in detergent sheet format may not contain significant amount of water, particularly free water. ‘Free water’ herein refers to water added or visually perceivable on the product. However, the process of making the detergent sheet comprises a step of preparing a solution of ingredients in a water and casting on a surface. Thus, it may contain water residue in it. Preferably the detergent sheet comprises less than 25% by weight, more preferably less than 20% by weight and most preferably less than 15% by weight water. Preferably the detergent sheet comprises 5 to 25% by weight, more preferably 5 to 20% by weight, even more preferably 8 to 15% by weight, most preferably 10 to 15% by weight of water and the water is bound to the detergent sheet. Water content may be measured in thermogravimetrically, such as moisture balance or thermogravimetric analyser.

The composition in sheet format may be prepared by preparing a liquid premix by adding the ingredient in water and casting the premix thereon a surface. Thereon the premix is casted on a surface as a sheet or film with certain thickness. Preferably the thickness is controlled using an applicator. Casting process includes removing the water by evaporation, thereby provides the detergent sheet. The casting may take place in room temperature or at an elevated temperature, preferably at less than 100° C., and more preferably less than 95° C. Most preferably the casting process takes place at 70 to 90° C. Process of making the detergent sheet may also include any other conventional method of forming film or sheets.

### Application

The cleaning composition according to the present invention may be formulated for laundering. The term ‘laundering’ herein refers to treating or washing fabrics. The laundering may include hand wash and machine wash. In hand wash, a consumer dissolves a unit dose of the cleaning composition in a bucket of water forming a wash liquor and soak their laundry load in the wash liquor and subsequently wash it. The cleaning composition may be used in machine wash also, wherein consumer dose a unit dose the cleaning composition in a washing machine directly and wash their load.

There is provided a process for cleaning a substrate comprising steps of providing water in a container, dissolving the cleaning composition in the water thereby providing a wash liquor and subsequently applying the wash liquor for cleaning the substrate. The substrate may be fabric and the cleaning process may include ‘laundering’. The laundering may include hand wash and machine wash. The container may be tub of a washing machine or a bucket or washing vessel in case of hand wash. Preferably the ratio of the cleaning composition to water preferably is in the range from 1:50 to 1:5000 by weight, more preferably 1:75 to 1:4000 by weight, event more preferably 1:100 to 1:3000 by wight and most preferably 1:150 to 1:2000 by weight.

### Example

Materials used in the examples are listed below in table 1.

TABLE 1

| Materials | Full form | Supplier |
|---|---|---|
| Na-LAS | Sodium linear alkyl benzene | Unger Surfactants, |
| | sulphonate | Norway |
| CAPB | Cocoamodipropyl betaine | — |
| NI (non-ionic surfactant) | Alkylpolyglucoside | — |
| HPMC (Cellulose | Hydroxypropyl | Shinetsu, Dow, |
| containing compound) | methylcellulose | Ashland |
| Glycerol | Glycerol | Sigma-Aldrich |
| Tinopal CBC | Distyryl biphenyl derivative | BASF SE |
| Acusol | Carboxylic copolymer | Dow Chemical |
| | | International Pvt. Ltd. |
| Dequest2010 | 1.Hydroxyethylidene.1,1- | Italmatch UK Ltd. |
| | diphosphonic acid | |
| EPEI | Ethoxylated Polyethyleneimine | BASF SE |
| Texcare | polyester based copolymers | Clarient Ltd. |
| MCC | Micro-crystalline cellulose | Keval Export. |
| Starch | Tapioca starch-grade A | SPAC Starch Products |
| | | Pvt. Ltd. |

Ex-1 and Ex-B were prepared in detergent sheet format. Hydroxypropyl methyl cellulose (HPMC) was available as dry powder, Ex-1 and B were prepared by dissolving it in hot water (80° C.) thereby providing a liquid premix. Rest of the ingredients were weighed according to the recipe provided in table 2 and mixed thoroughly to the premix. Subsequently the premix was casted on a surface using TQC Compact (TSC Sheen) film applicator with a draw-dawn applicator forming a wet film. The film was allowed to dry at 70 to 90° C. for 2 hours providing the composition in detergent sheet format.

Ex-A and C comparative compositions were prepared following the recipe provided in table 2. Ex-A was a liquid composition, as it did not contain a sheet forming polymer like hydroxypropyl methyl cellulose. Ex-C containing starch in place of HPMC was not a stable liquid, hence no further evaluation done with it.

TABLE 2

| Material (gm) | Ex-1 | Ex-A | Ex-B | Ex-C |
|---|---|---|---|---|
| Na-LAS | 4.0 | 4.1 | 4.1 | 4.1 |
| CAPB | 0.4 | 0.4 | 0.4 | 0.4 |
| NI | 0.5 | 0.5 | 0.5 | 0.5 |
| HPMC (Cellulose | 1.6 | 0.0 | 1.6 | 0.0 |
| derivative) | | | | |
| Starch | 0.0 | 0.0 | 0.0 | 1.6 |
| Glycerol | 0.2 | 0.2 | 0.2 | 0.2 |
| Tinopal | 0.1 | 0.1 | 0.1 | 0.1 |
| Acusol | 1.1 | 1.1 | 1.1 | 1.1 |
| Dequest | 0.4 | 0.4 | 0.0 | 0.4 |
| EPEI | 0.7 | 0.7 | 0.7 | 0.7 |
| Texacare | 0.4 | 0.4 | 0.4 | 0.4 |
| MCC | 0.7 | 0.7 | 0.7 | 0.7 |
| Water | 25.1 | 0.0 | 25.5 | 25.5 |
| Total weight (gm) | 35.2 | 8.6 | 34.8 | 35.2 |

The water content of the composition in sheet format was 10±2% by weight, measured by thermogravimetry. Thus, the amount of each ingredient with respect to the detergent sheet was estimated by normalising against the water content. Ex-A was normalised as such for comparing with rest of the example. Same is summarised in table 2A below:

TABLE 2A

| Material (% w/w) | Ex-1* | Ex-A | Ex-B* |
|---|---|---|---|
| Na-LAS | 35.6 | 47.7 | 37.1 |
| CAPB | 3.6 | 4.7 | 3.7 |
| NI | 4.5 | 5.8 | 4.6 |
| HPMC (Cellulose | 14.3 | 0.0 | 14.8 |
| derivative) | | | |
| Starch | 0.0 | 0.0 | 0.0 |
| Glycerol | 1.8 | 2.3 | 1.9 |
| Tinopal | 0.9 | 1.2 | 0.9 |
| Acusol | 9.8 | 12.8 | 10.2 |
| Dequest | 3.6 | 4.7 | 0.0 |
| EPEI | 6.2 | 8.1 | 6.5 |
| Texacare | 3.6 | 4.7 | 3.7 |
| MCC | 6.2 | 8.1 | 6.5 |
| Water | 10.0 | 0.0 | 10.0 |

*Cleaning composition in detergent sheet format

### Evaluation

Stain removal efficacy of each composition was evaluated in terms of SRI (Stain Removal Index). SRI is defined as:

$$SRI = 100 - Δ E , wherein$$

$${( Δ E )}^{2} = [ {( {L}_{B} - {L}_{S} )}^{2} + {( {a}_{B} - {a}_{S} )}^{2} + {( {b}_{B} - {b}_{S} )}^{2} ] ,$$

where L, a, b are colour value in CIELAB colour space and B indicate blank fabric (unstained) and S indicates stained fabric.

SRI for each composition for different stains were measured using ArtixScan F1 (Innotech Scanner) and summarised in table 3. Higher SRI values indicate better stain removal efficacy.

TABLE 3

| | SRI Values | | |
|---|---|---|---|
| Type of stains | Ex-1 | Ex-A | Ex-B |
| Red Curry | 83.7 | 79.1 | 82.9 |
| Dirty Motor oil | 89.6 | 86.3 | 87.3 |
| Red wine | 92.2 | 83.5 | 84.1 |
| Chocolate cream milk | 94.8 | 82.2 | 84.4 |

Form table 2A and 3, it is evident that Ex-1 containing less amount of surfactant compared to Ex-A provides significantly better cleaning (higher SRI values) on various types of stains. Ex B does not contain a cleaning booster, however same is compensated with the amount of surfactant, yet delivers inferior SRI values compared to Ex-1.

1. A laundry cleaning composition comprising:
a) 10 to 80% by weight of a surfactant;
b) at least 5% by weight of a cellulose containing compound having a solubility at least 0.5% by weight in distilled water at 25° C.; and,
c) a cleaning booster selected from sequestrant, soil release polymer, anti-redeposition polymer and combinations thereof.

2. A composition as claimed in claim 1 wherein the surfactant is selected from anionic surfactant, non-ionic surfactant, amphoteric surfactant, and combinations thereof.

3. A composition as claimed in claim 2 wherein the anionic surfactant is from 50 to 100% by weight of the total amount of the surfactant.

4. A composition as claimed in claim 2 wherein the surfactant is a combination of anionic surfactant, non-ionic surfactant, and amphoteric surfactant.

5. A composition as claimed in claim 1 wherein amount of the cellulose containing compound is in the range 5 to 50% by weight of the composition.

6. A composition as claimed in claim 1 wherein the cellulose containing compound is a cellulose ether derivative.

7. A composition as claimed in claim 6 wherein the cellulose ether derivative is selected form hydroxypropyl methyl cellulose, methyl cellulose, hydroxypropyl cellulose, ethyl cellulose, ethyl methyl cellulose, hydroxyethyl cellulose, hydroxy ethyl methyl cellulose, hydroxypropyl methyl cellulose, ethyl hydroxy ethyl cellulose, and combinations thereof.

8. A composition as claimed in claim 7 wherein the cellulose ether derivative is hydroxypropyl methyl cellulose.

9. A composition as claimed in claim 1 wherein the amount of the cleaning booster is in the range 0.1 to 20% by weight of the composition.

10. A composition as claimed in claim 1 wherein the cleaning booster is a sequestrant selected from amino-phosphonic acid, phosphonic acid, amino carboxylic acid, and salts thereof.

11. A composition as claimed in claim 1 wherein the cleaning booster is an anti-redeposition polymer comprising a polyethyleneimine.

12. A composition as claimed in claim 1 is in a detergent sheet format.

13. A unit does product comprising a composition as claimed in claim 1 contained in a water-soluble pouch.

14. A process for cleaning a substrate comprising steps of:
a) providing water in a container;
b) dissolving a cleaning composition as claimed in claim 1 in the water thereby providing a wash liquor; and
c) applying the wash liquor for cleaning the substrate.
